(19) United States
(12) Patent Application Publication
(10) Pub. No.: US 2007/0244620 A1
(43) Pub. Date: Oct. 18, 2007

(54) All Wheel Drive System

(76) Inventor: Edo Drenth, Helsingborg (SE)

Correspondence Address: ST. ONGE STEWARD JOHNSTON & REENS, LLC, 986 BEDFORD STREET, STAMFORD, CT, 06905-5619, US

(21) Appl. No.: 11/736,362

(22) Filed: Apr. 17, 2007

Related U.S. Application Data
(63) Continuation of application No. PCT/EP05/11126, filed on Oct. 17, 2005.

(30) Foreign Application Priority Data
Oct. 21, 2004 (SE) 0402539-1

(51) Int. Cl. B60T 7/12

(52) U.S. Cl. 701/81

(57) ABSTRACT

The present invention relates to a method for controlling a vehicle comprising an all-wheel drive coupling, which is engaged by a clutch, and an electronic stability program (ESP) system being connected to a brake system of the vehicle. In the method, the ESP system and the all-wheel drive coupling exchange information for improving the controllability of the vehicle during cornering. The invention also relates to an all-wheel drive system for performing the above method.

### CROSS-REFERENCE TO RELATED APPLICATIONS

The present application is a continuation of pending International patent application PCT/EP2005/011126 filed on Oct. 17, 2005 which designates the United States and claims priority from Swedish patent application 0402539-1 filed on Oct. 21, 2004, the content of which is incorporated herein by reference.

### FIELD OF THE INVENTION

The present invention relates to an all-wheel drive system for a road vehicle and more specifically to an all-wheel drive system for a road vehicle which is also provided with an ESP (Electronic Stability Program) system. It also relates to a method for controlling said all-wheel drive system.

### BACKGROUND OF THE INVENTION

Background of the Invention Road vehicles provided with previous all-wheel drive “hang-on” systems encounter problems with excessive understeer, when utilized in the midrange velocity envelope. Understeer is the phenomenon that a vehicle requires a larger than normal steering angle in order to follow a curve. This can be experienced as uncomfortable and annoying by an active driver, since the vehicle can be more difficult to control.

An engineering challenge with all-wheel drive systems is to detect a reference vehicle velocity, since all wheels are driven and theoretically may suffer from wheel spin. Traditionally, this is solved by introducing a clutch action, which would make the wheels free-rolling. Such action may, however, be sensed by the driver as a disturbance.

### SUMMARY OF THE INVENTION

It is an object of the present invention to provide an all-wheel drive system that overcomes the above-mentioned problems. The object is achieved by a method according to claim 1 and a system according to claim 7. Practical embodiments are set forth in sub-claims.

### BRIEF DESCRIPTION OF THE DRAWINGS

The present invention is presented with reference to the appended drawings, in which

FIG. 1 is a flowchart of an all-wheel drive system according to the invention, and

FIG. 2 is a schematical representation of a vehicle with an all-wheel drive system of the present invention.

### DETAILED DESCRIPTION OF THE INVENTION

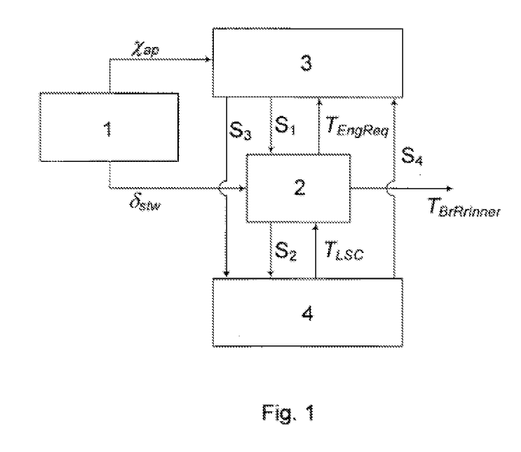

A flow-chart for an all-wheel drive system for a road vehicle, especially a car, according to the present invention can be seen in FIG. 1.

In operation, a driver 1 gives input to the all-wheel drive system in the form of a steering angle, δ_{stw}, which is sent to an ABS (Antilock Braking System)/ESP (Electronic Stability Program) unit 2, and an accelerator pedal position, Xₐₚ, which is sent to an engine management system 3. The engine management system 3 outputs information regarding e.g. an operating condition and the demand from the driver Si to the ABS/ESP unit 2 and it may also receive information from the ABS/ESP unit 2 e.g. in the form of a torque request, T_{EngReq}. The ABS/ESP unit 2 may send signal (s) S₂ to an all-wheel drive coupling 4, such as a limited slip coupling (LSC) or a clutch, if e.g. cornering is demanded, and it may receive signal (s) from the all-wheel drive coupling 4 about a transferred torque T_{LS}c- The ABS/ESP unit 2 can also provide a braking torque for a rear inner wheel, r_{βrBr}iₙₙₑᵣ- The normal communication between the engine management system 3 and the all-wheel drive coupling 4 is represented by S₃. The all-wheel drive coupling 4 can also send a signal directly to the engine management system 3, and this is denoted as S₄ in FIG. 1.

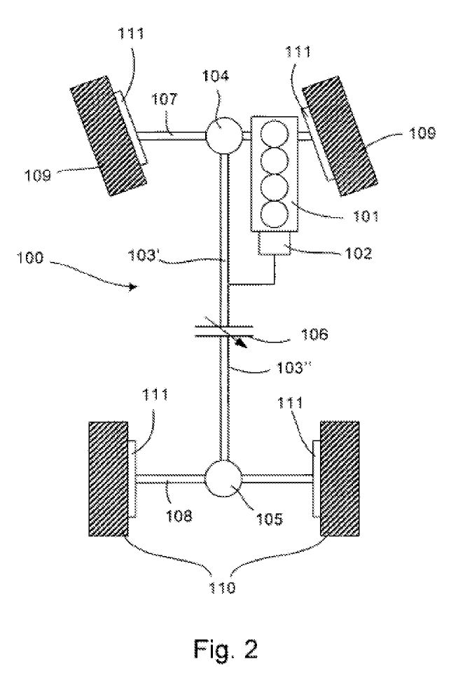

A vehicle 100 provided with an all-wheel drive system can be seen in FIG. 2. The vehicle 100 is equipped with an engine 101, a transmission 102 for transferring a motive torque from the engine to a primary drive shaft 103′, a secondary drive shaft 103″, a front 104 and a rear 105 differential and an all-wheel drive coupling 4, 106, transferring torque from the primary 103′ to the secondary drive shaft 103″ or vice versa under certain circumstances. The differentials 104, 105 are coupled to front 107 and rear 108 wheel axles, respectively, which are coupled to front 109 and rear wheels 110, having brakes 111 mounted thereto. The wheel axles 107, 108 are comprised of two half shafts coupled to the differential 104 and 105, respectively. The engine 101, brakes 111 and all-wheel drive coupling 4, 106 are all associated with electronic control units (ECU:s) which are not depicted in FIG. 2. Said associated ECU:s ensure communication between the different components of the vehicle.

The vehicle can, but must not necessarily for all properties, further be equipped with sensors (not shown) for detecting different properties of the vehicle, such as wheel speeds, temperatures, pressures etc. Unmeasured properties that are necessary for control may be calculated from the measured properties of the above sensors.

If the ABS/ESP unit 2 during cornering gently applies a brake torque to the rear inner wheel T_{B}rRrinneTT which is about half the magnitude of the torque transferred over the all-wheel drive coupling 4 (on wheel level, after the final drive), the longitudinal slip between the rear inner tire and the road surface will be small. This phenomenon can be used for obtaining a vehicle reference velocity without having to use any disturbing clutch opening action, since the rear differential 105 in this case will transfer nearly all torque, transferred to the wheel axle, to the unbraked wheel and leave the braked wheel coasting or “free-rolling”. It will be sufficient to ensure brake torques that result in net driving forces below the vertical wheel load multiplied with the surface friction and an exact match is not necessary for carrying out the invention. The friction and the vertical wheel load are not exactly known, and the net driving forces should hence be notably below an estimated value.

Another application for the above-disclosed system can involve a reduction of understeer that arises in an all-wheel drive vehicle during cornering. Again, by gently applying a brake torque T_{BrRrlnner} to the rear inner wheel (which causes a yaw moment), in conjunction with the torque transfer over the all-wheel drive coupling 4, the vehicle will thus obtain a more neutral-steer characteristic in the midrange velocity envelope. A normal ABS/ESP system provides this kind of gentle braking to a selected wheel, but the inclusion of the all-wheel drive coupling 4, 106 transferring torque to the secondary drive shaft 103″, reduces much of the discomfort previously encountered in this case. This is caused by the fact that the net yaw moment of the applied brake force is higher and thus on average lower brake torques are required. For instance, in the extreme case it is possible to generate a yaw moment, even when there is no vertical wheel load on the curve inner wheel. The applied brake torque results in a reduced net motive torque, which is why the ABS/ESP unit 2 sends or may send signal (s), T_{EngReql} to the engine management system 3 requiring more torque to be outputted from the engine, in order not to lose speed. This added torque should never exceed the equivalent brake torque from the ABS/ESP system, since this will result in more acceleration without such a signal being sent by the driver. The vehicle is in a state which does not allow any torque or only a limited amount of torque to be transferred from the front wheels to the rear wheels, due to cornering effects at elevated velocities, but the gentle braking of the rear inner wheel makes a torque transfer possible. The thus achieved control authority is one of the features of the present invention.

The above all-wheel drive system is cheap to implement, since it does not require any additional hardware. It can further improve the dynamic performance as noted above. The increased communication between the ABS/ESP unit 2 and the all-wheel drive coupling 4, for computations of reference velocity, may also improve safety and comfort for all-wheel drive vehicles. The term slip is used for a property that is always present between a road surface and a wheel that is driven by a torque. The slip is controllable when it is below approximately 15% (this value depends e.g. on tire manufacture and road surface conditions). When the slip is higher, the wheel starts to accelerate rapidly and less torque can be transferred to the road surface. This phenomenon is commonly known as a spinning wheel.

Even though a specific embodiment has been described above it will be evident to a person skilled in the art to make modifications to the present invention without departing from the scope of the invention as defined by the appended claims. The term clutch in this application everywhere refers to a feature of the all-wheel drive system. It is not necessary to have an ABS system in the ESP system, and any type of brake system will thus suffice. The invention is shown with the primary drive shaft being the front drive shaft but this is not necessary, since the rear drive shaft instead can be the primary drive shaft.

1. A method for controlling a vehicle comprising an all-wheel drive coupling, which is engaged by a clutch, and an electronic stability program (ESP) system being connected to a brake system of the vehicle, where said ESP system and the all-wheel drive coupling exchange information, characterized in that the method comprises the steps of
a) braking a rear, inner wheel using the ESP system for achieving a control authority of a torque transfer over the all-wheel drive coupling and a yaw moment of the vehicle, and
b) using the obtained control authority to transfer torque from a primary drive shaft to a secondary drive shaft utilizing the all-wheel drive coupling,
for reducing understeer of the vehicle during cornering.

2. A method according to claim 1, wherein a signal relating to the applied brake torque is transferred to the engine management system for increasing an output from an engine in order to compensate for the braking action.

3. A method according to claim 2, wherein the increase in output from the engine never exceeds the applied net brake torque from the ESP system.

4. A method according to claim 1, said method comprising the steps of
a) determining the amount of torque that is transferred over the all-wheel drive coupling,
b) braking an inner wheel of a secondary driven wheel shaft, using the ESP system, an amount that corresponds to about half the torque transferred by the all-wheel drive coupling resulting in a motive force on the perimeter of said wheel (tire surface) that is below the maximum friction force from the road surface, and
c) measuring the velocity of the braked wheel, which is now substantially unaffected by any torque and is hence more or less coasting or free-rolling,
in order to obtain a reference velocity of the vehicle.

5. A system for controlling a vehicle, said system comprising an all-wheel drive coupling, which is engaged by a clutch, and an electronic stability program (ESP) system being connected to a brake system of the vehicle, characterized in that the ESP system communicates with the all-wheel drive coupling for improving the controllability of the vehicle during cornering.

6. A system according to claim 5, wherein a sensor is arranged in order to measure or estimate a torque that is transferred over the all-wheel drive coupling.

7. A system according to claim 6, wherein a sensor is arranged in order to measure or estimate a velocity of a wheel of the vehicle.
